(19) United States
(12) Patent Application Publication
(10) Pub. No.: US 2009/0265918 A1
(43) Pub. Date: Oct. 29, 2009

(54) SYSTEM AND METHOD FOR AUTOMATED PRODUCTION OF RF CHOKES

(76) Inventor: Oleg DOUNAEVSKY, Netanya (IL)

Correspondence Address: Pearl Cohen Zedek Latzer, LLP, 1500 Broadway, 12th Floor, New York, NY, 10036, US

(21) Appl. No.: 12/359,554

(22) Filed: Jan. 26, 2009

Related U.S. Application Data
(60) Provisional application No. 61/047,150, filed on Apr. 23, 2008.

(51) Int. Cl. H01F 27/30

(52) U.S. Cl. 29/606

(57) ABSTRACT

System and method that permits fully automated production of RF hybrid devices or chokes comprised of electrical wires and a main body made of ferrite toroids are disclosed. RF chokes produced according to current invention may be used as directional couplers, in-phase splitters, balanced/unbalanced (BALUN) matching devices, radio frequency (RF) transformers etc., and may achieve high repeatability and improved electrical performance without adversely affecting electrical characteristics of the RF hybrid devices.

### BACKGROUND OF THE INVENTION

Known technique of RF hybrid devices with frequencies band beginning from 1 or 5 MHz requires ferrite toroid core that can not be cut for purpose of wire-wound process in the plane contains coaxial line. As a result, wire-wound process through toroid hole until now involves hand-made labor resulting high costs and low accuracy and repeatability.

### SUMMARY OF THE INVENTION

An RF choke production method is disclosed. The method comprises cutting a flat multi-wire cable at a desired length, inserting the multi-wire cable through one or more cavities of a main body made of magnetically permeable material, the ends of the wires of multi-wire flat cable may be connected to each-other after insertion of the flat cable through the choke (main body) body, to form a multi-windings coil with the required configuration of the required windings and taps. An RF choke produced according to embodiments of the invention may be used as a directional coupler, an in-phase splitter, a balanced/unbalanced (BALUN) matching device, a radio frequency (RF) transformers etc.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic isometric view illustration of a choke and a side view of a flat multiwire cable used with said choke according to embodiments of the present invention;

FIG. 2 is schematic top view of a choke according to embodiments of the present invention;

FIG. 3A is a schematic partial cross-section side view of a choke according to embodiments of the present invention; and

FIG. 3B is a cross-section front view of a choke according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

RF hybrid devices comprising of chokes for operation in the range of, for example from 1-5 MHz and up to 1 GHz or more, utilize typically a ferrite core, for example in the shape of a toroid, having typically one or two cavities through the toroid substantially parallel to its longitudinal axis. Due to the nature of the materials of which the toroid is typically made and to its physical small dimensions winding the wires constituting the wounds of the choke is quite complicated and requires laborious manual work. This manual work involves threading the wire repeatedly through the one or two cavities to form the coil of the choke. Evidently this method for producing a choke suffers from relatively low commercial efficiency and low accuracy of the choke's electrical parameters.

According to embodiments of the present invention production of a small-size RF choke may be automated and have high level of accuracy and repeatability of its electrical characteristics.

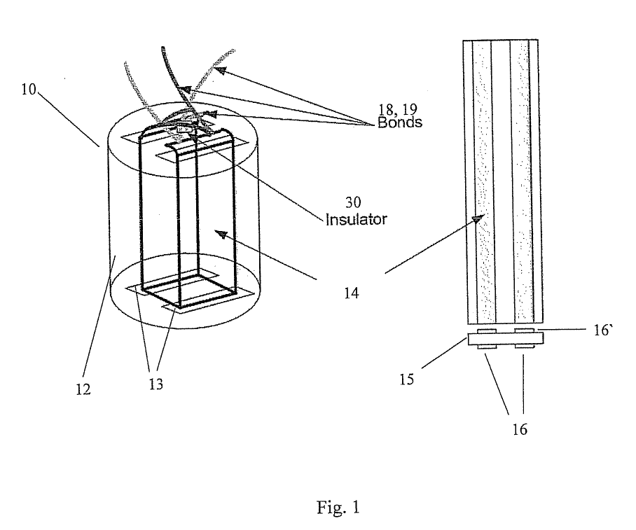

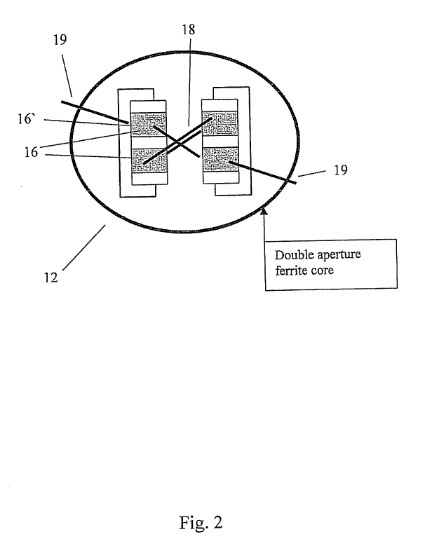

Referring now to FIGS. 1 and 2 which are a schematic isometric view illustrations of a choke 10 and a side view of a flat multi wire cable used with choke 10 and a schematic top view of the choke 10, respectively, according to embodiments of the present invention. Choke 10 may comprise a main body 12 having one or more cavities 13 extending therethrough. Main body 12 may be made of a material with high magnetic permeability, such as for example, ferrite. Cavities 13 may typically be made along lines substantially parallel to a longitudinal axis of main body 12. Main body 12 may have, for example, a cylindrical shape. However, it shall be apparent to a person skilled in the art that the shape of main body and the material or materials of which it is made, as well as the shape, number, location and direction of cavities 13, may vary as may be dictated by the specific requirements of the device. Choke 10 may further comprise a multi-wire flat cable 14, comprising of one or more flat insulation stripes 15 (only one is shown in FIG. 1) and one or more layers of flat conductors, or wires 16 and 16′ applied on at least one of the faces of insulator stripe 15 and separated by said insulation stripes 15 along an axis substantially perpendicular to the plane of insulation layer. Flat conductors may also be separated from one another in each stripes layer by placing them apart from each other, by using an insulation coating or any other known method. Multi-wire flat cable 14 may be at least partially flexible to enable bending to form a desired bent, such as U-shape, as clearly seen in FIG. 1, so as to enable insertion of the flat cable 14 (bent in a U shape) through cavities 13 of main body 12 of choke 10.

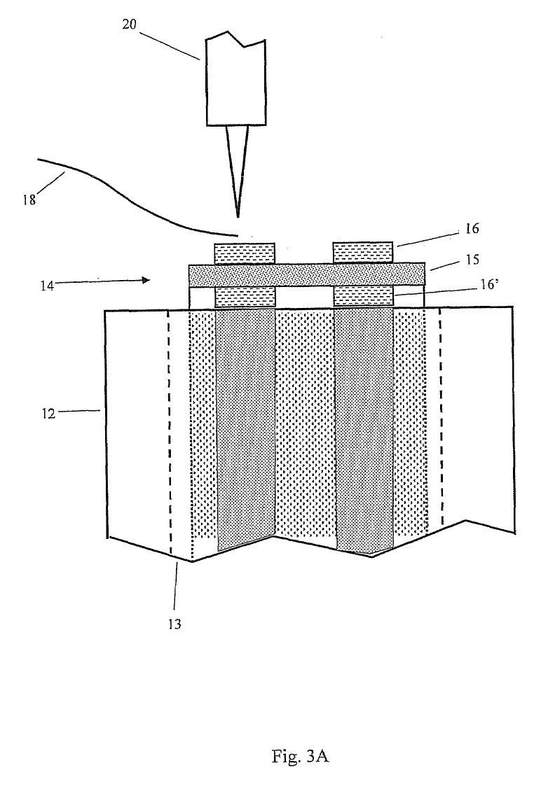

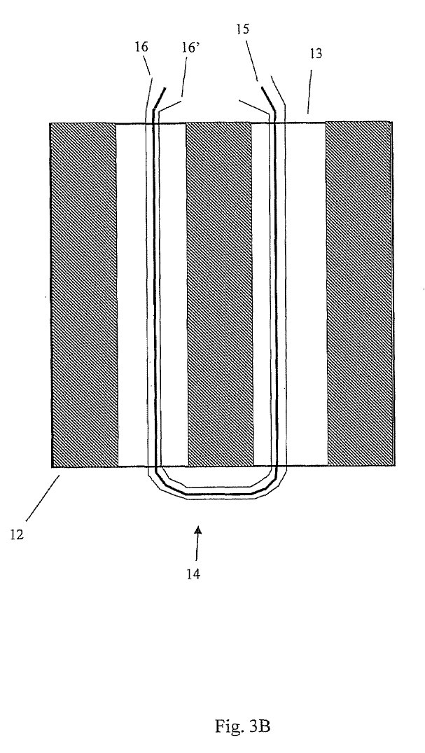

Referring now also to FIGS. 3A and 3B, which are a schematic partial cross-section side view of choke 10 and a cross-section front view of choke 10, respectively, according to embodiments of the present invention. In order to make an RF choke, flat cable 14 may be inserted through cavities 13, so that its loose ends slightly protrude beyond a second end of main body 12 after flat cable 14 has been inserted into cavities 13 of main body 12 from its first end. Once flat cable 14 has been inserted to its place, loose ends of conductors 16, 16′ may be connected to one another by wires 18 and/or to connection terminals by wires 19 presented in FIG. 2, as may be required, according to the specific electrical characteristics of choke 10. For example, as seen in FIG. 2, loose ends 16 and 16′ of multi-wire flat cable 14, may be connected by connecting wires 18, 19 to form any desire winding, comprising a desired number of turns and a desired number and electrical location of taps in the choke's windings.

According to embodiments of the present invention the production of RF choke 10 may be automated, where the cutting of flat cable 14, the shaping of flat cable 14 into U-shape and the insertion of U-shaped flat cable 14 into cavities 13 of main body 12 may easily be automated, typically using well known production equipment. After flat cable 14 has been inserted into cavities 13, the loose ends 16, 16′ of the multi-wire may be connected in a desired direction, to each-other, to taps or to device terminals, as may be required, using automated soldering, automated ultrasonic soldering or bonding equipment 20 to connect wires 18 (or 19) to loose ends 16, 16′ so as to fulfill the required electrical configuration. Additionally, and as may be required, insulator 30 may be used, as needed, to insulate between wires and connection points.

It will be apparent to a person skilled in the art that the specific form and dimensions of main body 12 and of cavity/cavities 13, as well as the number of wires in multi-wire flat cable 14, the size and type of flat cable 14, and the configuration of connections and taps connecting loose ends 16, 16′ to one another—are all a matter of choice enabling the planning and production of a RF choke 10 as needed. It will also become apparent that an RF choke 10 produced according to embodiments of the present invention is easier to produce, requiring less production time, less human labor and achieve higher grade of accuracy, compared with RF chokes produced according to known methods. RF choke 10 produced according to embodiments of the present invention may be formed and used as a directional coupler, an in-phase splitter, a balanced/unbalanced (BALUN) matching device, radio frequency (RF) transformers etc.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An apparatus comprising:
a main body made of a magnetically permeable material, having at least one cavity through it; and
a multi-wire flat cable having at least two wires held on a flat insulation material, wherein the ends of said wires are connected to each other according to a desired scheme after said flat wire has been inserted through said at least one cavity.

2. The apparatus of claim 1, wherein said magnetically permeable material is ferrite.

3. The apparatus of claim 1, wherein said main body is in the shape of toroid.

4. The apparatus of claim 1, wherein said multi-wire cable is partially flexible.

5. The apparatus of claim 1, wherein said apparatus production is automated.

6. The apparatus of claim 1, wherein said ends of said wires are connected using automated connecting means, said connecting means selectable from a list comprising soldering, ultrasonic soldering and bonding.

7. The apparatus of claim 1, further comprising insulator to insulate between wires and connection points.

8. A RF choke production method comprising:
cutting a flat multi-wire cable at a desired length;
inserting said flat multi-wire cable through one or more cavities of a main body made of magnetically permeable material so that the two ends of said flat multi-wire cable are close to each other;
connecting by conductive material loose ends of wires in said multi-wire cable to each-other to form a continuous conductor having a required number of turns encircling said main body through its cavity.

9. The method of claim 8, wherein said magnetically permeable material is ferrite.

10. The method of claim 8, wherein said main body is in the shape of toroid.

11. The method of claim 8, wherein said multi-wire cable comprising a flat insulation stripe and at least one flat conductor.

12. The method of claim 8, wherein said multi-wire cable is partially flexible.

13. The method of claim 8, further comprising connecting said loose ends of wires to connection terminals.

14. The method of claim 8, wherein said production method is automated.

15. The method of claim 8, wherein said connecting of said loose ends is done using automated connecting means, said connecting means selectable from a list comprising soldering, ultrasonic soldering and bonding.

16. The method of claim 8, further comprising using insulator to insulate between wires and connection points.
